(19) United States
(12) Patent Application Publication
(10) Pub. No.: US 2005/0010646 A1
(43) Pub. Date: Jan. 13, 2005

(54) E-mail management server, attachment file output system, attachment file output method, recording medium, and program data signal

(76) Inventor: Toshio Shiina, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/885,726

(22) Filed: Jul. 8, 2004

(30) Foreign Application Priority Data
Jul. 8, 2003 (JP) 2003-193445
Jul. 8, 2003 (JP) 2003-193446

(51) Int. Cl. G06F 15/16

(52) U.S. Cl. 709/207

(57) ABSTRACT

An e-mail management server receives an e-mail, destined to a portable terminal, that has an attachment file attached, separates the e-mail to text and attachment file, and stores the attachment file. Then, a URL of the attachment file is added to the text and sent to the portable terminal. Receiving instructions for printing the attachment file and URL of the attachment file from the portable terminal, the e-mail management server reads the attachment file that the URL indicates, converts it to an image data that can be printed by the printer, and sends it to the printer. In a case where there is an instruction to transmit a facsimile of an attachment file from the portable terminal, the e-mail management server sets the sending destination of the image data to the facsimile server.

### BACKGROUND OF THE INVENTION

1. Field of the Invention

The present invention relates to an e-mail management server, an attachment file output system, an attachment file output method, a recording medium, and a program data signal for printing data attached to an e-mail, etc.

2. Description of the Related Art

E-mail, which is widely used in recent years, can be formed so that image data and data having a data format of a specific dedicated application program are attached to a text made of text data, as an attachment file. The text and the attached attachment file can be sent/received integrally.

In a case where a printer is connected to the terminal that receives e-mail, (or in a case where the terminal comprises a printer), in addition to the text of the e-mail, the content of the attachment file can also be printed.

However, there are cases where it is not necessary for the receiver of the terminal that receives e-mail, to print the attachment file, and there are also cases where the receiver of the terminal that receives e-mail, can not carry out printing.

To solve these kinds of problems, an art of arbitrary selecting whether to print an attachment file or not, by the receiver of the terminal that receives e-mail, is disclosed in Unexamined Japanese Patent Application KOKAI Publication No. 2003-44413. The content of this document is incorporated herein by reference in its entirety.

### SUMMARY OF THE INVENTION

However, in a case where the receiver of the terminal of the e-mail can not print the attachment file, there is no meaning in simply having the user select printing or not, because the terminal can not carry out printing.

On the other hand, in a case where the terminal that receives e-mail, is a terminal such as a portable phone, in many cases, the attachment file can not be browsed, as well as not being able to be printed. In order to confirm the content of the attachment file, it is convenient for the user of such terminal, if the hard copy of that attachment file can also be obtained. Therefore, a structure that can provide a hard copy of the attachment file also to the user of such terminal is desired.

The present invention has been made in consideration of the above, and the object of the present invention is to provide an e-mail management server, an attachment file output system, an attachment file output method, a recording medium, and a program data signal for providing a hard copy of an attachment file to users of a terminal wherein browsing and printing of the attachment file of the e-mail is difficult.

To achieve the above object, an e-mail management server according to a first aspect of the present invention, comprises:

e-mail receiving means for receiving an e-mail sent to a terminal via a network;

attachment file separating means for separating the e-mail that the e-mail receiving means receives, to a text and an attachment file;

attachment file storing means for storing the attachment file separated by the attachment file separating means, to a predetermined storage region;

e-mail sending means for sending an e-mail that has added to the text, an address of the storage region where the attachment file is stored, via the network;

address receiving means for receiving the address included in the e-mail sent by the e-mail sending means, and

attachment file output controlling means for controlling a predetermined output device to output the attachment file, by reading the attachment file from the storage region, which the address that the address receiving means receives indicates, and sending the attachment file to the output device via the network.

An attachment file output system according to a second aspect of the present invention, comprises a terminal, an output device, and an e-mail management server connected to the terminal and the output device via a network,

wherein the e-mail management server comprises:

first e-mail receiving means for receiving an e-mail sent to the terminal via the network;

attachment file separating means for separating the e-mail that the first e-mail receiving means receives, to a text and an attachment file;

attachment file storing means for storing the attachment file separated by the attachment file separating means, to a predetermined storage region;

e-mail sending means for sending an e-mail that has added to the text, an address of the storage region where the attachment file is stored, via the network;

address receiving means for receiving the address included in the e-mail sent by the e-mail sending means, and

attachment file output controlling means for controlling a predetermined output device to output the attachment file, by reading the attachment file from the storage region, which the address that the address receiving means receives indicates, and sending the attachment file to the output device via the network.

The attachment file output system, wherein:

the terminal may comprise:

second e-mail receiving means for receiving the e-mail sent by the e-mail sending means, and

attachment file output instructing means for instructing output of the attachment file to the e-mail management server, by sending the address included in the e-mail that the second e-mail receiving means receives, to the e-mail management server via the network, in accordance with the user inputting instructions for the attachment file to be output.

The attachment file output system, wherein:

the output device may be a printing device which prints files sent from the e-mail management server, via the network;

the attachment file output instructing means may include attachment file printing instructing means for instructing printing of the attachment file to the e-mail management server, by sending the address to the e-mail management server via the network, in accordance with the user inputting instructions for the attachment file to be printed, and

the attachment file output controlling means may include attachment file printing controlling means for controlling the first printing apparatus to print the attachment file, by reading the attachment file from the storage region, which the address that the address receiving means receives indicates, and sending the attachment file to the output device via the network.

The attachment file output system, wherein:

the output device may be a facsimile server that transmits the file sent from the e-mail management server via the network, to a facsimile device designated by the user;

the attachment file output instructing means may include attachment file facsimile transmitting controlling means for controlling a facsimile server to transmit the attachment file to a facsimile device indicating the facsimile number, by reading the attachment file from the storage region, which the address that the address receiving means receives indicates, and sending the attachment file together with the facsimile number, to the facsimile server, via the network, and

the attachment file output controlling means may include attachment file transmitting means for controlling the facsimile server to transmit the attachment file to the facsimile device that the facsimile number indicates, by reading the attachment file from the storage region, which the address that the address receiving means receives indicates, and sending the read attachment file together with the facsimile number to the facsimile server via the network.

The attachment file output system, wherein:

the attachment file output instructing means may include user identification information sending means for sending user identification information that can specify a user, together with the address, to the e-mail management server via the network, in response to the user inputting instructions to output the attachment file;

the e-mail management server may further comprise user authentication means for carrying out authentication of the user, based on user identification information sent by the user identification information sending means, and

the attachment file output controlling means may include attachment file sending stopping means for stopping sending of the attachment file to the output device, in a case where authentication of the user by the user authentication means is a failure.

The attachment file output system, wherein:

the output device may be a printing device that prints a file sent from the e-mail management server via the network;

the terminal may include address writing means for writing the address included in the e-mail sent by the e-mail sending means, to a predetermined recording medium, and

the printing device may comprise

attachment file sending requesting means for requesting sending of an attachment file to the e-mail management server, by reading the address from the recording medium, and sending the read address to the e-mail management server via the network,

attachment file receiving means for receiving the attachment file sent from the e-mail management server via the network, in accordance with a request by the attachment file sending requesting means, and

attachment file printing means for printing the attachment file received by the attachment file receiving means.

The attachment file output system, wherein:

the attachment file sending requesting means may include user identification information sending means for sending user identification information that can specify the user, together with the address, to the e-mail management server, via the network;

the e-mail management server may further comprise user authentication means for authenticating the user, based on user identification information sent by the user identification information sending means, and

the attachment file output controlling means may include attachment file sending stopping means for stopping sending of the attachment file to the output device, in a case where authentication of the user by the user authentication means is a failure.

The attachment file output system, wherein:

the output device may be structured so that it can be connected to the terminal, and is a printing device that prints a file sent from the e-mail management server via the network and the terminal;

the terminal may include address storing means for storing the address included in the e-mail sent by the e-mail sending means, to a predetermined recording medium, and

the printing device may comprise

attachment file sending requesting means for requesting sending of an attachment file to the e-mail management server, by reading the address from the recording medium, and sending the read address to the e-mail management server via the terminal and the network,

attachment file receiving means for receiving the attachment file sent from the e-mail management server via the network and the terminal, in accordance with a request by the attachment file sending requesting means, and

attachment file printing means for printing the attachment file received by the attachment file receiving means.

The attachment file output system, wherein:

the attachment file sending requesting means may include user identification information sending means for sending user identification information that can specify a user, together with the address, to the e-mail management server via the terminal and the network;

the e-mail management server may further comprise user authentication means for carrying out authentication of the user, based on user identification information sent by the user identification information sending means, and

the attachment file output controlling means may include attachment file sending stopping means for stopping sending of the attachment file to the output device, in a case where authentication of the user by the user authentication means is a failure.

An attachment file output method according to a third aspect of the present invention, comprises:

an e-mail receiving step of receiving an e-mail sent to a terminal via a network;

an attachment file separating step of separating the e-mail that the e-mail receiving step receives, to a text and an attachment file;

an attachment file storing step of storing the attachment file separated by the attachment file separating step, to a predetermined storage region;

an e-mail sending step for sending an e-mail that has added to the text, an address of the storage region where the attachment file is stored, via the network;

an address receiving step of receiving the address included in the e-mail sent by the e-mail sending step, and

an attachment file output controlling step for controlling a predetermined output device to output the attachment file, by reading the attachment file from the storage region, which the address that the address receiving step receives indicates, and sending the attachment file to the output device via the network.

A computer readable recording medium according to a fourth aspect of the present invention, stores a program for controlling a computer to execute:

an e-mail receiving procedure for receiving an e-mail sent to the terminal via the network;

an attachment file separating procedure for separating the e-mail that the first e-mail receiving procedure receives, to a text and an attachment file;

an attachment file storing procedure for storing the attachment file separated by the attachment file separating procedure, to a predetermined storage region;

an e-mail sending procedure for sending an e-mail that has added to the text, an address of the storage region where the attachment file is stored, via the network;

an address receiving procedure of receiving the address included in the e-mail sent by the e-mail sending procedure, and

an attachment file output controlling procedure for controlling a predetermined output device to output the attachment file, by reading the attachment file from the storage region, which the address that the address receiving procedure receives indicates, and sending the attachment file to the output device via the network.

A program data signal according to a fifth aspect of the present invention, is embedded in a carrier wave, and is sent via a communication path, for controlling a computer to execute:

an e-mail receiving procedure for receiving an e-mail sent to the terminal via the network;

an attachment file separating procedure for separating the e-mail that the first e-mail receiving procedure receives, to a text and an attachment file;

an attachment file storing procedure for storing the attachment file separated by the attachment file separating procedure, to a predetermined storage region;

an e-mail sending procedure for sending an e-mail that has added to the text, an address of the storage region where the attachment file is stored, via the network;

an address receiving procedure of receiving the address included in the e-mail sent by the e-mail sending procedure, and an attachment file output controlling procedure for controlling a predetermined output device to output the attachment file, by reading the attachment file from the storage region, which the address that the address receiving procedure receives indicates, and sending the attachment file to the output device via the network.

### BRIEF DESCRIPTION OF THE DRAWINGS

These objects and other objects and advantages of the present invention will become more apparent upon reading of the following detailed description and the accompanying drawings in which:

FIG. 1 is a block diagram showing the structure of an attachment file output system according to a first embodiment of the present invention;

FIG. 2 is a block diagram showing the structure of a portable terminal shown in FIG. 1;

FIG. 3 is a block diagram showing the structure of an e-mail management server shown in FIG. 1;

FIG. 4 is a block diagram showing the structure of a printer shown in FIG. 1;

FIG. 5 is a block diagram showing the structure of a facsimile server shown in FIG. 1;

FIG. 6 is a flowchart showing attachment file output processing carried out in the attachment file output system shown in FIG. 1;

FIG. 7 is a block diagram showing the structure of an attachment file output system according to a second embodiment of the present invention;

FIG. 8 is a block diagram showing the structure of the portable terminal shown in FIG. 7;

FIG. 9A is a block diagram showing the structure of the printer shown in FIG. 7;

FIG. 9B is a block diagram showing the structure of the printer shown in FIG. 7, and

FIG. 10 is a flowchart showing attachment file output processing carried out in the attachment file output system shown in FIG. 7.

### DETAILED DESCRIPTION OF THE PREFERRED EMBODIMENTS

Below, embodiments of the present invention will be described with reference to the drawings, using an attachment file output system for printing or sending to a facsimile an attachment file attached to an e-mail, as an example.

### First Embodiment

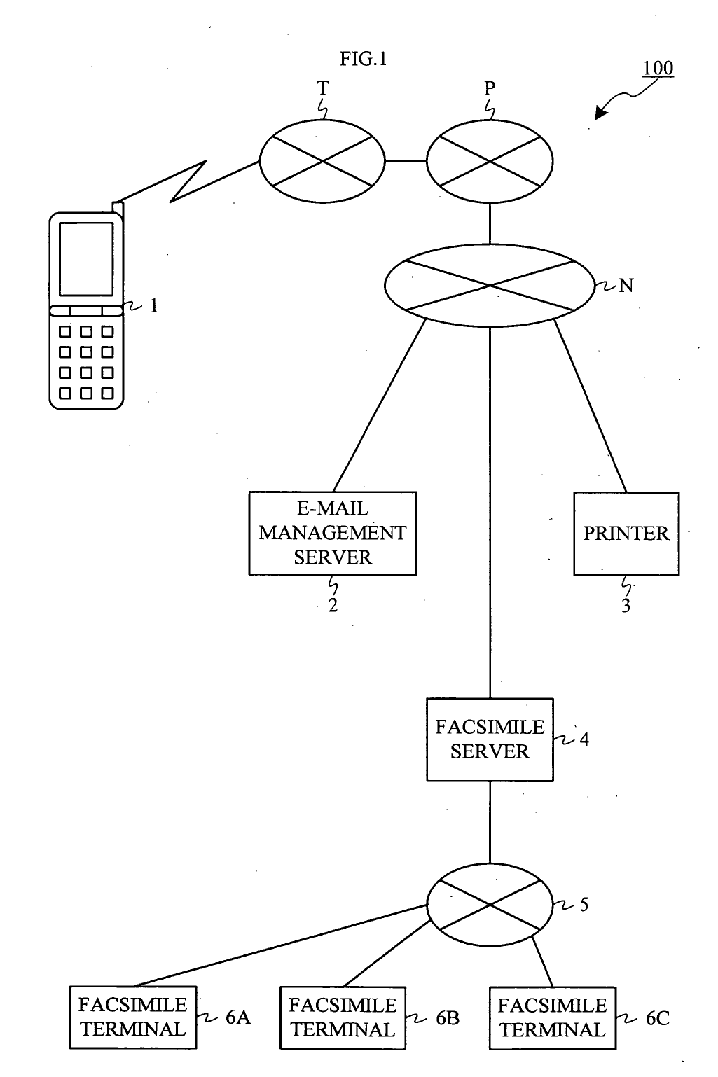

First, an attachment file output system 100 according to a first embodiment of the present invention will be described with reference to the diagram shown in FIG. 1.

As shown in FIG. 1, the attachment file output system 100 is constituted by a portable terminal 1, an e-mail management server 2, a printer 3, a facsimile server 4, a facsimile network 5, and facsimile terminals 6A to 6C.

A unique telephone and an e-mail address are allotted to the portable terminal 1. Identification codes (for example, IP (Internet Protocol) address) unique to each of the e-mail management server 2, the printer 3, and the facsimile server 3 are allotted.

The portable terminal 1 has a portable structure, and is a terminal that functions as a terminal of a mobile telephone (for example, a cellular phone, a PHS (Personal Handyphone System), or a GSM (Global System for Mobile communications)), etc. The portable terminal 1 is connected to an external packet-switching network P via an external telephone line network T, including a radio communication line.

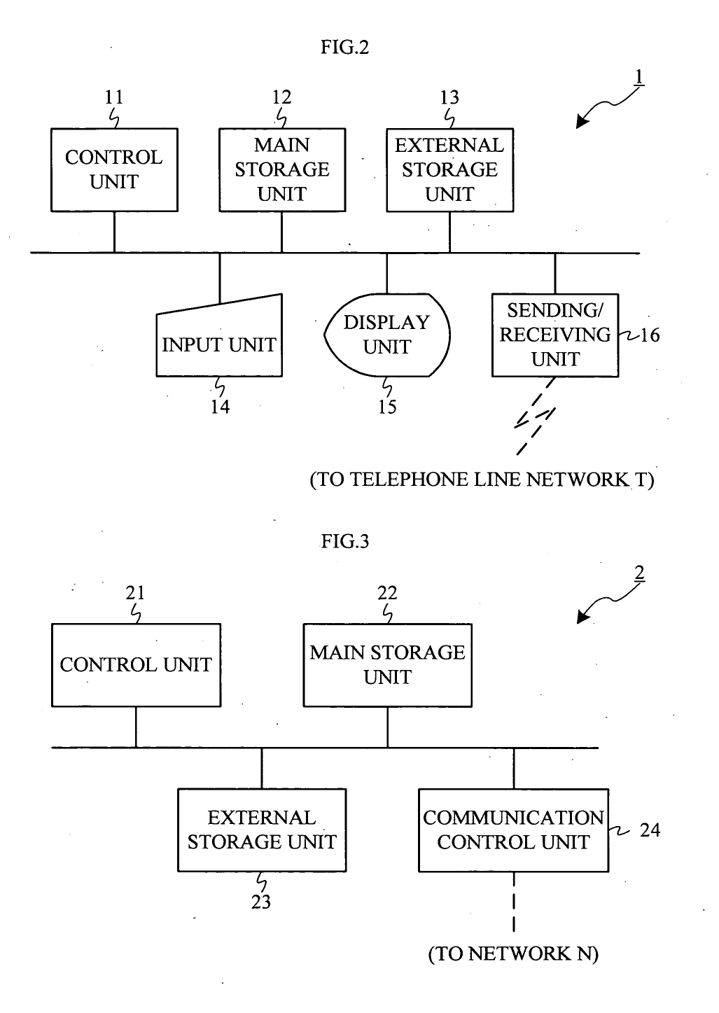

As for example, shown in FIG. 2, the portable terminal 1 comprises a control unit 11, a main storage unit 12, an external storage unit 13, an input unit 14, a display unit 15, and a sending/receiving unit 16. Each of the main storage unit 12, the external storage unit 13, the input unit 14, the display unit 15, and the sending/receiving unit 16 is connected to the control unit 11, via an internal bus.

The control unit 11 is constituted by a processor, such as a CPU (Central Processing Unit), etc., and executes a later described processing, in accordance with a program that the program data stored in the external storage unit 13 indicates.

The main storage unit 12 is constituted by a volatile memory, such as a RAM (Random Access Memory), etc., and is used as an operation region of the control unit 11.

The external storage unit 13 is constituted by a volatile memory, such as a flash memory, etc., and stores in advance, data of programs, etc., for controlling the control unit 11 to carry out the later-described processing. The external storage unit 13 supplies the data that the external storage unit 13 stores to the control unit 11, in accordance with instructions from the control unit 11.

The input unit 14 is constituted by a button, a switch, etc., and supplies information in accordance with operation of an operator, to the control unit 11.

The display unit 15 is constituted by an LCD (Liquid Crystal Display), etc., and displays an image in accordance with instructions from the control unit 11, on a display screen that the display unit 15 comprises.

The sending/receiving unit 16 is constituted by a radio transmitter and a radio receiver, etc., and is connected to the control unit 11 via the internal bus. In accordance with the information supplied from the control unit 11, the sending/receiving unit 16 modulates a carrier wave by a predetermined form, and sends a modulation wave via the telephone line network T (or directly) to the packet-switching network P.

The sending/receiving unit 16 receives a modulation wave that indicates information (for example, information having the e-mail address of the portable terminal 1 added) to a portable terminal 1, from the packet-switching network P, via the telephone line network T, and demodulates the modulation wave. Then, the sending/receiving unit 16 supplies the information destined to the terminal 1, obtained by modulation, to the control unit 11.

The telephone line network T shown in FIG. 1 includes a base station used for communication between telephones, such as mobile phones and stationary phones, and is connected to the packet-switching network P. The telephone line network T receives the modulation wave that the sending/receiving unit 16 of the portable terminal 1 sends, demodulates the modulation wave, and sends the information obtained by modulation to an external device (for example, another portable terminal, etc.) that a sending destination indicates, via the packet-switching network P.

The telephone line network T receives from the packet-switching network P, the information sent to the packet-switching network P destined to the portable terminal 1, from another external terminal, and generates a modulation wave indicating the received information, and sends the information to the portable terminal 1.

The packet-switching network P intermediates the switching of information between the apparatuses connected to the packet-switching network P, and intermediates the switching of information between the apparatuses that are connected to the packet-switching network P and the apparatuses that are not connected to the packet-switching network P, via a network N. The network N is constituted by, for example, the Internet.

For example, as shown in FIG. 3, the e-mail management server 2 is constituted by a control unit 21, a main storage unit 22, an external storage unit 23, and a communication control unit 24. Each of the main storage unit 22, the external storage unit 23, and the communication control unit 24 is connected to the control unit 21, via the internal bus.

The control unit 21 is constituted by a processor, such as a CPU, etc., and executes a later described processing, in accordance with a program that is stored in the external storage unit 23.

The main storage unit 22 is constituted by a volatile memory, such as a RAM, etc., and is used as an operation region of the control unit 21.

The external storage unit 23 is constituted by a volatile memory, such as a hard disk device, etc., and stores in advance, programs, etc., for the control unit 21 to carry out the later described processing, and data of a user information database, etc. The external storage unit 23 stores the data supplied from the control unit 21, and supplies the data that the external storage unit 23 stores, to the control unit 21, in accordance with instructions from the control unit 21.

The user information database that the external storage unit 23 stores, stores correlating the e-mail address allotted to the portable terminal that the user uses, and the user ID and password allotted to this user, with each other.

The communication control unit 24 is constituted by a modem, etc., and is connected to the control unit 21 via the internal bus. The communication control unit 24 intermediates data exchange between the control unit 21 and external apparatuses, via the network N, in accordance with instructions from the control unit 21.

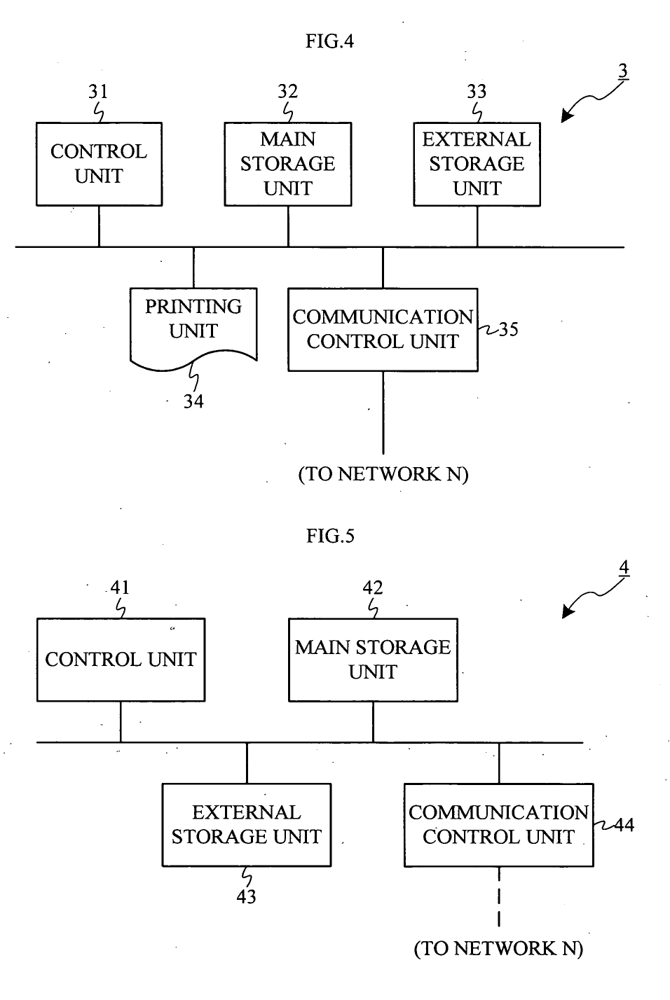

For example, as shown in FIG. 4, the printer 3 is constituted by a control unit 31, a main storage unit 32, an external storage unit 33, a printing unit 34, and a communication control unit 35. Each of the main storage unit 32, the external storage unit 33, the printing unit 34, and the communication control unit 35 is connected to the control unit 31 via the internal bus.

The control unit 31 is constituted by a processor, such as a CPU, etc., and executes a later described processing, in accordance with a program that is stored in the external storage unit 33.

The main storage unit 32 is constituted by a volatile memory, such as a RAM, etc., and is used as an operation region of the control unit 31.

The external storage unit 33 is constituted by a volatile memory, such as a hard disk device, etc., and stores in advance, programs, etc., for the control unit 31 to carry out the later described processing. The external storage unit 33 stores the data supplied from the control unit 31, and supplies the programs and data that the external storage unit 33 stores, to the control unit 31.

The printing unit 34 is constituted by a printer head and a sheet feeder, etc., and prints characters and figures in accordance with instructions supplied from the control unit 31, to the surface of a sheet made of paper, etc.

The communication control unit 35 is constituted by a modem, etc., and is connected to the control unit 31 via the internal bus. The communication control unit 35 intermediates data exchange between the control unit 31 and external apparatuses, via the network N, in accordance with instructions from the control unit 31.

For example, as shown in FIG. 5, the facsimile server 4 is structured by a control unit 41, a main storage unit 42, an external storage unit 43, and a communication control unit 44. Each of the main storage unit 42, the external storage unit 43, and the communication control unit 44 is connected to the control unit 41 via the internal bus.

The control unit 41 is constituted by a processor, such as a CPU, etc., and carries out processing of relaying transmission of an image between facsimile terminals 6A to 6C, and an external facsimile terminal apparatus, etc., in accordance with the program stored in the external storage unit 43.

Concretely, when the facsimile terminals 6A to 6C supply a telephone number (facsimile) of another party to whom an image is to be transmitted, and image data representing the image to be transmitted, to the control unit 41, via the facsimile network 5 and the communication control unit 44, the image data is sent to the facsimile terminal of the other party, via the communication control unit 44 and the telephone line network T.

In a case where an image data destined to any of the facsimiles 6A to 6C is supplied to the facsimile server 4 from an external facsimile terminal, etc., via the telephone line network T, the image data is received via the communication control unit 44, and the image data is supplied to the facsimile terminal which is a sending destination, via the communication control unit 44 and the facsimile network 5.

The main storage unit 42 is constituted by a volatile memory, such as a RAM, etc., and is used as an operation region of the control unit 41.

The external storage unit 43 is constituted by a volatile memory, such as a hard disk device, etc., and stores in advance, the above program for the control unit 41 to carry out processing of relaying transmission of an image between the facsimile terminals 6A to 6C and the external facsimile device, etc. The external storage unit 43 stores the data supplied from the control unit 41, and supplies the programs and other data that the external storage unit 43 stores, to the control unit 41, in accordance with instructions from the control unit 41.

The communication control unit 44 is constituted by a modem, etc., and is connected to the control unit 41 via the internal bus, and is connected to the network N via the telephone line network T (or, the communication control unit 44 may have a structure of being connected to the telephone line network T and at the same time being connected to another network N, without passing through the telephone line network T).

The communication control unit 44 intermediates data exchange via the network N, between the control unit 41 and the external apparatus, in accordance with instructions from the control unit 41. The communication control unit intermediates transmission of image data between the control unit 41 and the target facsimile apparatus, etc., in accordance with instructions from the control unit 41.

The facsimile network 5 shown in FIG. 1 is constituted by a network, such as a LAN (Local Area Network), etc. The facsimile network 5 connects the facsimile server 4 and the facsimile terminals 6A to 6C, and intermediates data exchange between the facsimile server 4 and the facsimile terminals 6A to 6C.

The facsimile terminals 6A to 6C respectively have substantially the same structure, and each is connected to the facsimile network 5. The facsimile server 4 that carries out the above processing intermediates each of the facsimile terminals 6A to 6C, so as to carry out image transmission with the external facsimile device, etc.

Concretely, the facsimile terminals 6A to 6C read a manuscript (a sheet made of paper, etc.) set by an operator, and generate image data representing the image of the manuscript. Then, the facsimile terminals 6A to 6C obtain the telephone number (facsimile) of the other party who is to be sent the image, in accordance with the operation by the operator, and send the image data and the telephone number to the facsimile server 4 via the facsimile network 5.

As a result, the image data is transmitted to the other party by the facsimile server 4. When an image data destined to oneself is supplied from the facsimile server 4 via the facsimile network 5, the image data is obtained and characters and figures that the image data indicate, are printed on a surface of a sheet.

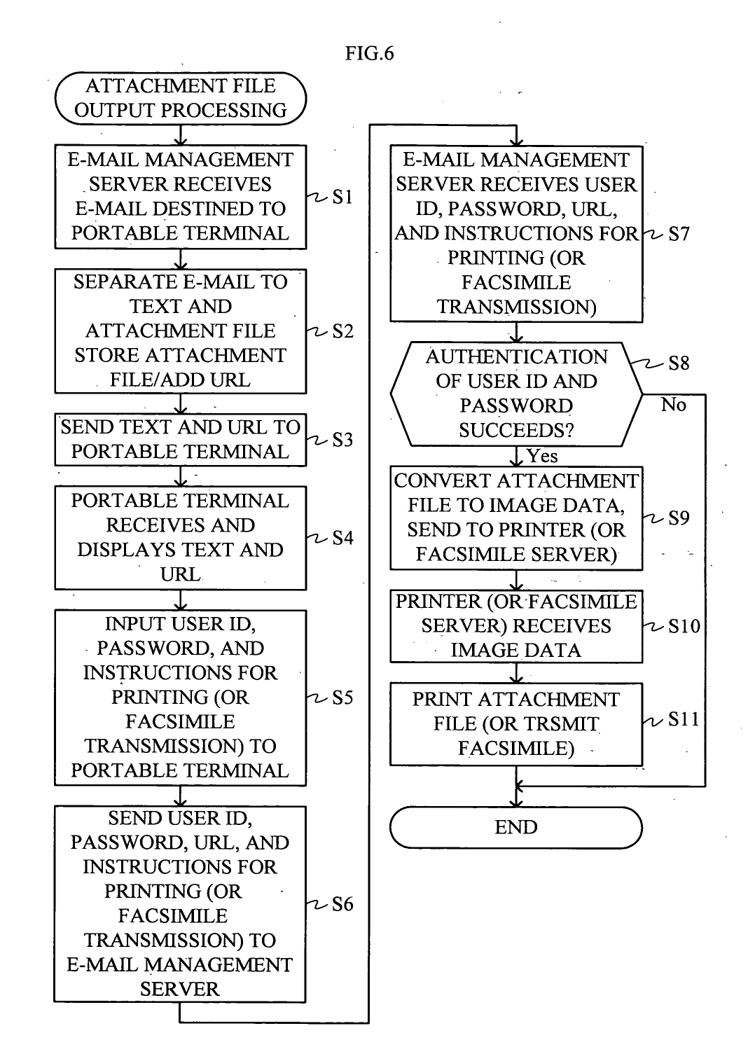

Next, operation (attachment file output processing) of the attachment file output system 100 having the above structure, will be described with reference to the flowchart shown in FIG. 6.

In this attachment file output processing, as shown in FIG. 6, the control unit 21 of the e-mail management server 2 receives an e-mail which is sent destined to the portable terminal 1, via the network N, at the communication control unit 24 (step S1).

Then, the control unit 21 separates the e-mail received in the processing of step S1, to the text and the attachment file, stores the separated attachment file to a storage region of the external storage unit 23, and allots a unique URL (Uniform Resource Locator) to the attachment file, at a storage position where the attachment file is stored (step S2).

Sequentially, the control unit 21 adds the URL of the attachment file allotted in the processing of step S2 to the text of the e-mail separated in the processing of step S2, and sends from the communication control unit 24, the e-mail that has the URL added to the text, to the portable terminal 1 which is the original destination, via the network N, the packet-switching network P, and the telephone line network T (step S3).

The control unit 11 of the portable terminal 1 receives the e-mail sent from the e-mail management server 2, at the sending/receiving unit 16, and displays the received text of the e-mail and information indicating that a file is attached to the e-mail, for example the URL of the attachment file, is displayed on the screen of the display unit 15 (step S4).

The user operates the input unit 14, and when the user ID, password, and an instruction for printing the attachment file are input (step S5), the control unit 11 sends the input user ID, password, URL of the attachment file, and instruction for printing the attachment file to the e-mail management server 2 (concretely, by adding for example, an IP address allotted to the e-mail management server 2), from the sending/receiving unit 16, via the telephone line network T, the packet-switching network P, and the network N (step S6).

The control unit 21 of the e-mail management server 2 receives the user ID, password, URL of the attachment file, and the instruction for printing the attachment file, sent from the portable terminal 1, at the communication control unit 24 (step S7), and carries out authentication of the received user ID and password (step S8). Concretely, whether the received user ID and password are the user ID and password allotted to the user of the portable terminal 1, is determined by searching the user information database that the external storage unit 23 stores.

In a case where the authentication of the user ID and password fails, (step S8; No), the attachment file output processing ends.

On the other hand, in a case where the authentication of the user ID and password succeeds, (step S8; Yes), the attachment file is read from the storage position that the URL received in the processing of step S7. The attachment file is converted to a data format that can be printed by the printer 3 (for example, Post Script (trademark)), and the image data obtained by conversion is sent from the communication control unit 24 to the printer 3 via the network N (step S9).

The control unit 31 of the printer 3 receives the image data sent from the e-mail management server 2 (step S10), and prints the image of the attachment file that the image data indicates, at the printing unit 34 (step S11).

In the processing of step S5, the user may input an instruction for facsimile transmission of the attachment file and the facsimile number of the other party who is to be sent a facsimile, instead of an instruction for printing the attachment file (or together with the instruction for printing the attachment file).

In this case, in the processing of step S6, the control unit 11 sends the instruction for facsimile communication of the attachment file and the facsimile number from the sending/ receiving unit 16 to the e-mail management server 2, via the telephone line network T, the packet-switching network P, and the network N.

In the processing of step S7, the control unit 21 of the e-mail management server 2 receives the instruction for transmitting a facsimile and facsimile number of the other party, together with the user ID, password, and the URL of the attachment file, and carries out authentication of the user ID and password, in the processing of step S8.

In a case where authentication of the user ID and password succeeds in the processing of step S9, the attachment file is read out, and converted to a data format that can be sent by the facsimile server 4, and the image data obtained by conversion is sent from the communication control unit 24 to the facsimile server 4 via the network N, together with the facsimile number of the other party.

In a case where the attachment file is already in a data format that can be sent by the facsimile server 4, the processing of step S9 can be omitted.

In the processing of step S10, the control unit 41 of the facsimile server 4 receives the image data and the facsimile number sent from the e-mail management server 2, and in the processing of step S11, the control unit 41 starts communication between the facsimile terminal 6 that has this facsimile number and the portable terminal 1, and sends the image data from the communication control unit 44 to the facsimile terminal 6 of the other party, via the facsimile netwwork 5.

According to the above described attachment file output system, in a case where an attachment file is attached to an e-mail destined to the portable terminal 1, the attachment file is separated from the text of the e-mail and stored to the e-mail management server 2. Instead of the attachment file itself, the address of the storage position of the attachment file is notified to the portable terminal 1.

Then, when the portable terminal 1 instructs printing of the attachment file and/or facsimile transmission, and sends the address of the attachment file to the e-mail management server 2, the attachment file is printed by the printer 3, and/or the attachment file is sent to the facsimile by the facsimile server 4.

Therefore, even if an e-mail that has an attachment file attached is sent to a portable terminal 1 that can not display the content of the attachment file, printing and/or facsimile transmission of the attachment file can be carried out by the portable terminal 1.

### Second Embodiment

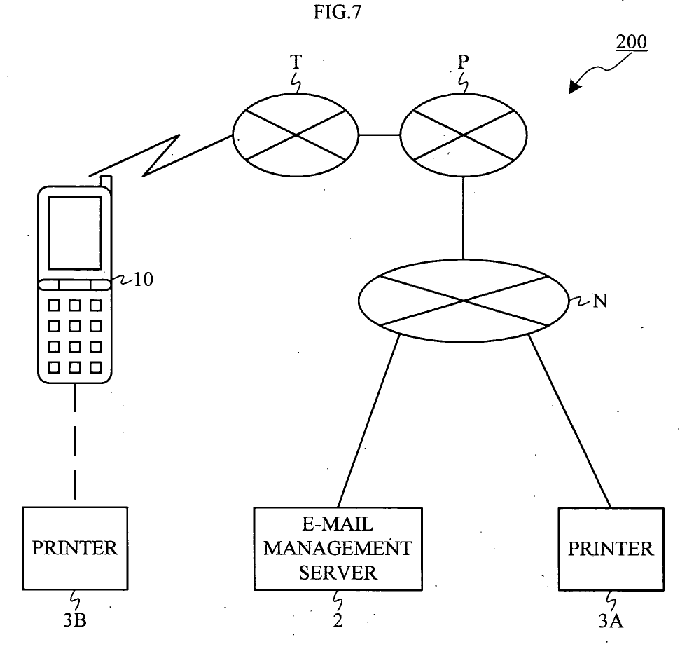

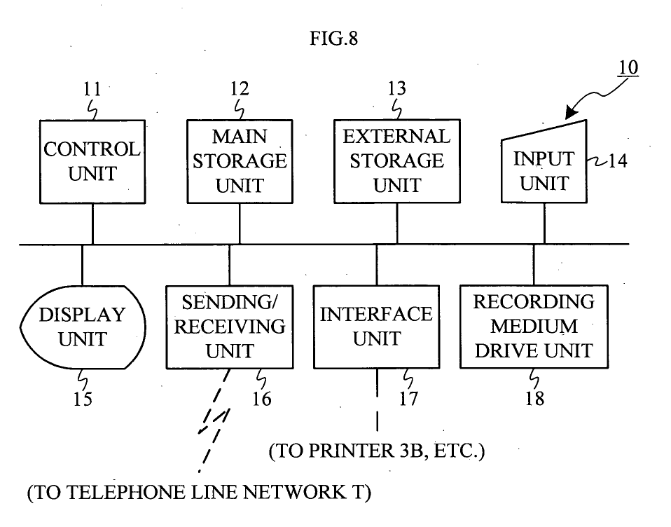

Next, an attachment file output system 200 according to a second embodiment of the present invention will be described with reference to FIG. 7. Descriptions for the parts that overlap with the first embodiment, will be omitted by putting the same reference numerals on the drawings.

As shown in FIG. 7, the attachment file output system 200 is constituted by a portable terminal 10, an e-mail management server 2, a printer 3A, and a printer 3B.

For example, as shown in FIG. 8, the portable terminal 10 comprises a control unit 11, a main storage unit 12, an external storage unit 13, an input unit 14, a display unit 15, a sending/receiving unit 16, an interface unit 17, and a recording medium drive unit 18. Each of the main storage unit 12, the external storage unit 13, the input unit 14, the display unit 15, the sending/receiving unit 16, the interface unit 17, and the recording medium drive is connected to the control unit 11, via an internal bus.

The interface unit 17 is constituted by a USB (Universal Serial Bus) controller, etc. The interface unit 17 intermediates serial transmission carried out between the devices connected to the interface unit 17 and the control unit 11.

The recording medium drive unit 18 is constituted by a recording medium drive device that accesses to a recording medium (for example, SD memory (trademark), Smart Media (registered trademark), and memory stick (registered trademark), etc.). The recording medium drive unit 18 accesses to the recording medium set at the recording medium drive unit 19 in accordance with an instruction from the control unit 11, reads data from the recording medium and supplies the data to the control unit 11, and writes the data that the control unit 11 supplies, to the recording medium.

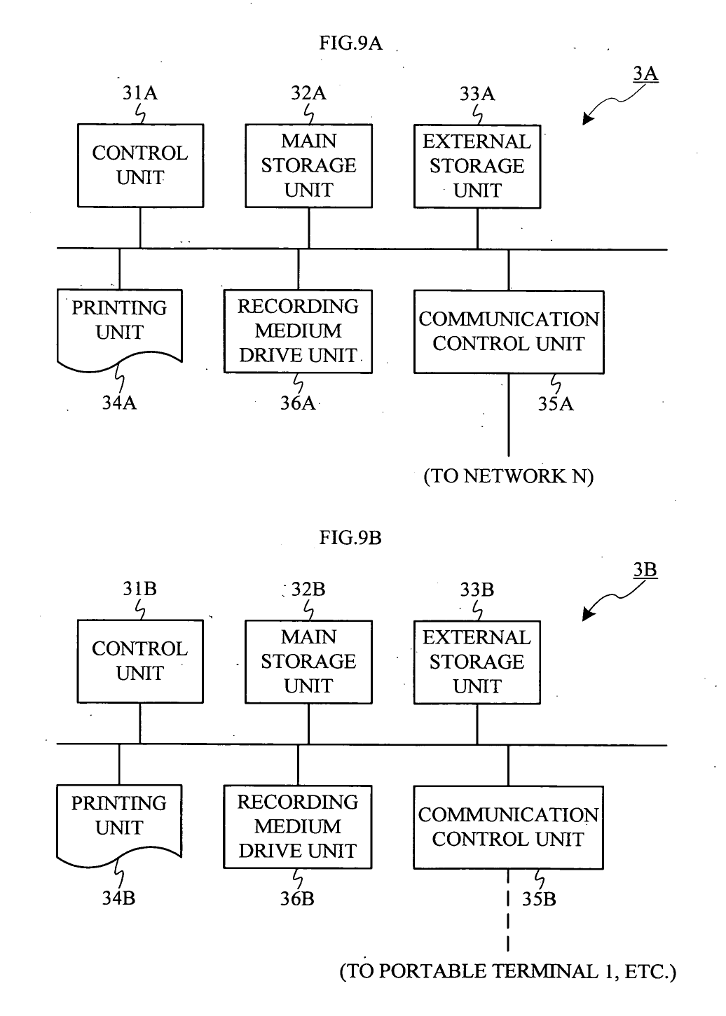

For example, as shown in FIG. 9A, the printer 3A is constituted by a control unit 31A, a main storage unit 32A, an external storage unit 33A, a printing unit 34A, a communication control unit 35A, and a recording medium drive unit 36A.

Each of the main storage unit 32A, the external storage unit 33A, the printing unit 34A, the communication control unit 35A, and the recording medium drive unit 36A is connected to the control unit 31A via the internal bus. The control unit 31A, the main storage unit 32A, the external storage unit 33A, the printing unit 34A, the communication control unit 35A, are substantially the same as the control unit 31, the main storage unit 32, the external storage unit 33, the printing unit 34, and the communication control unit 35, of the printer 3.

The recording medium drive unit 36A is constituted by a recording medium drive device that accesses to a recording medium that the recording medium drive unit 18 of the portable terminal 10 can access. The recording medium drive unit 36A accesses to the recording medium set at the recording medium drive unit 36A, in accordance with an instruction from the control unit 36A, reads data from the recording medium and supplies the data to the control unit 31A, and writes the data that the control unit 31A supplies, to this recording medium.

For example, as shown in FIG. 9B, the printer 3B is constituted by a control unit 31B, a main storage unit 32B, an external storage unit 33B, a printing unit 34B, an interface unit 35B, and a recording medium drive unit 36B. Each of the main storage unit 32B, the external storage unit 33B, the printing unit 34B, the interface unit 35B, and the recording medium drive unit 36B is connected to the control unit 31B via the internal bus.

The control unit 31B, the main storage unit 32B, the external storage unit 33B, the printing unit 34B, and the recording medium drive unit 36B are substantially the same as the control unit 31A, the main storage unit 32A, the external storage unit 33A, the printing unit 34A, and the recording medium drive unit 36A of the printer 3A. However, the printer 3B differs from the printer 3A, in that the printer 3B does not have a function to directly connect to the network N.

The interface unit 36B of the printer 3B is constituted by a serial interface circuit, such as a USB controller, etc., and intermediates serial transmission carried out between a device connected to the interface unit 36B and the control unit 31B.

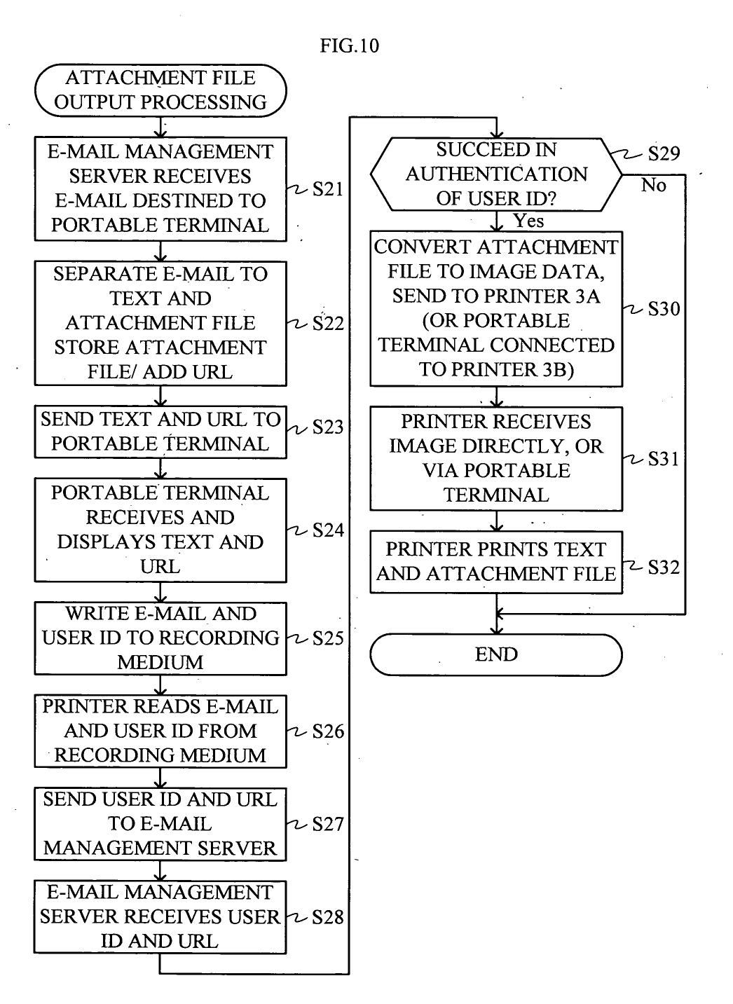

Next, operation (attachment file output processing) of the attachment file output system 200 that has the above structure, will be described with reference to the flowchart shown in FIG. 10.

Processing of steps S21 to S23 shown in FIG. 10 is the same processing as the processing of steps S1 to S3 shown in FIG. 6.

After the processing of step S24, the user sets the recording medium to the recording medium drive unit 18. When the user operates the input unit 14 to input instructions for writing a user ID and an e-mail, the control unit 11 of the portable terminal 10 controls the recording medium drive unit 18 to write the input user ID, and text of the e-mail and the URL of the attachment file, received in the processing of step S24, to the recording medium (step S25).

When the user sets the recording medium that has the e-mail and user ID written, in the processing of step S25, to the recording medium drive unit 36A of the printer 3A, the recording medium drive unit 36A reads the e-mail and user ID from the recording medium, and supplies them to the control unit 31 (step S26).

Then, the control unit 31 A sends the user ID and the URL of the attachment file included in the e-mail supplied from recording medium drive unit 36A to the e-mail management server 2, via the network N (concretely, for example, by adding the IP address allotted to the e-mail management server 2) (step S27).

The control unit 21 of the e-mail management server 2 receives the user ID and the URL of the attachment file sent from the printer 3, at the communication control unit 24 (step S28), and authenticates the received user ID (step S29). Concretely, for example, the e-mail management server 2 determines whether the received user ID is the user ID allotted to the user of the portable terminal 10, by searching the user information database that the external storage unit 23 stores.

In a case where the authentication of the user ID is a failure, (namely, in a case where it is determined that the received user ID is not the user ID that is allotted to the user of the portable terminal 10) (step S29; No), the control unit 21 ends the attachment file output processing.

On the other hand, in a case where the authentication of the user ID and password succeeds, (step S29; Yes), the attachment file is read from the storage position that the URL received in the processing of step S28. The attachment file is converted to a data format that can be printed by the printer 3A (for example, Post Script (trademark)), and the image data obtained by conversion is sent from the communication control unit 24 to the printer 3A via the network N (step S30).

In a case where the attachment file is already in a data format that can be printed by the printer 3A, the processing of step S30 can be omitted.

The control unit 31 of the printer 3A receives the image sent from the e-mail management server (step S31), and prints the image of the attachment file that the image data indicates, and the text of the e-mail supplied in the processing of step S28, at the printing unit 34A (step S32).

The user may set the recording medium that has the user ID and the e-mail written-in, to the recording medium drive unit 36B of the printer 3B, instead of the recording medium drive unit 36A of the printer 3A, in the processing of step S26. In this case, in the processing of step S26, the recording medium drive unit 36B reads the e-mail and user ID from the recording medium, and supplies them to the control unit 31B. At this time, the interface unit 17 of the portable terminal 10 and the interface unit 35B of the printer 3B are connected to each other via a cable, etc.

In the processing of step S27, the control unit 31B supplies the user ID supplied from the recording medium drive unit 36B, and the URL of the attachment file included in the e-mail supplied from the recording medium drive unit 36B, to the portable terminal 10, via the interface unit 35B. Then, the control unit 11 of the portable terminal 10 sends the user ID and URL of the attachment file included in the e-mail, supplied from the printer 3B, from the sending/receiving unit 16 to the e-mail management server 2, via the telephone line network T, the packet-switching network P, and the network N.

In the processing of step S28, the control unit 21 of the e-mail management server 2 receives the user ID and the URL of the attachment file, and carries out authentication of the user ID, in the processing of step S29.

In a case where authentication of the user ID succeeds, in the processing of step S30, the attachment file is read, and converted to a data format that can be printed by the printer 3B, and the image data obtained by the conversion is sent from the communication control unit 24 to the printer 3A, via the network N.

In the processing of step S31, the control unit 11 of the portable terminal 10 receives the image data sent from the e-mail management server 2, and further supplies the received image data to the printer 3B. In the processing of step S32, the control unit 31B of the printer 3B prints the image of the attachment file that the image data supplied from the portable terminal 10 indicates, and the text of the e-mail supplied in the processing of step S26, at the printing unit 34B.

According to the attachment file output system described above, in a case where an attachment file is attached to an e-mail sent to the potable terminal 10, the attachment file is separated from the text of the e-mail, and stored in the e-mail management server 2. An address of the storing position of the attachment file is notified to the portable terminal 10, instead of the attachment file, itself. The portable terminal 10 sends the text of the e-mail and address of the attachment file, to the recording medium, and when the recording medium is set to the printer 3A or 3B, the printer 3A or 3B directly or via the terminal 10, sends the address of the attachment file to the e-mail management server 2, and obtains image data of the attachment file. By the printer 3A or 3B, the text of the e-mail and the attachment file is printed. Therefore, even if an e-mail that has an attachment file attached is sent to a portable terminal 10 that can not display the content of the attachment file, printing of the attachment file can be carried out.

The present invention is not limited to the above embodiments, and various changes and modifications are possible. Below, modifications of the above embodiments that can be applied to the present invention, will be descried.

For example, the attachment file output system may comprise a plurality of portable terminals and printers. In a case where the attachment file output system comprises a plurality of printers 3, 3A, portable terminals 1, 10 may obtain information that designate a printer for carrying out printing of the attachment file, in accordance with the operation, etc., of the user, and send this information to the e-mail management server 2, in the processing of step S27. Then, in the processing of step S9 and step S30, the e-mail management server 2 may send the image data indicating the attachment file to the printers 3, 3A designated by this information.

In the processing of step S8 and step S29, the e-mail management server 2 does not necessarily have to carry out authentication of the user ID and password, and may be structured so that right after the processing of step S7 and step S28, the step moves to the processing of step S9 and step S30. In this case, the printer 3A and the portable terminals 1, 10 do not have to send the user ID and password to the e-mail management server 2.

Further, the portable terminals 1, 10 may store the user ID and password in advance. In this case, it is not necessary for the portable terminals 1, 10 to obtain the user ID and password, in accordance with the user's operation, etc., and the portable terminals 1, 10 may send the user ID and password that the portable terminals 1, 10 store, and write them to the recording medium, in the processing of step S25.

In the processing of step S8, the e-mail management server 2 may carry out authentication using an apparatus ID that is uniquely allotted to the portable terminals 1, 10, instead of authenticating the user ID and password allotted to the user. In this case, the portable terminal 1 stores a unique apparatus ID in advance, and sends the apparatus ID that the portable terminal 1 stores, instead of the user ID and password, in the processing of step S26.

Further, in the processing of step S29, the e-mail management server 2 may carry out authentication using the apparatus ID uniquely allotted to the printer 3A, instead of authenticating the user ID allotted to the user, (or, together with authenticating the user ID). In this case, in the processing of step S27, the printer 3A sends the apparatus ID of the printer 3A together with the URL of the attachment file, to the e-mail management server 2.

Above, embodiments of the present invention have been described. However, the attachment file output system according to the present invention may be realized without using a dedicated system, but by using an ordinary computer system.

For example, by installing a program from a medium (CD-ROM, MO, flexible disk, etc.) that stores the program for executing the operations of the e-mail management server 2, to a server computer that can connect to a mobile phone which can carry out printing or packet communication via a network, the attachment file output system that executes the above processing can be structured.

For example, this program may be uploaded to a Bulletin Board System (BBS) of a communication line, and may be distributed via the communication line. A signal that indicates this program may modulate a carrier wave, the obtained modulation wave may be transmitted, and the device that receives the modulation wave may restore the program by demodulating the modulation wave.

The above processing can be executed by driving this program, and executing the program in the same way as other application programs, under the control of an OS.

In a case where the OS shares a part. of the processing, or in a case where the OS structures a part of a component of the present invention, a program excluding that part may be stored to the recording medium. In this case also, in the present invention, it is assumed that each function that the computer executes, or the program for executing the steps is stored in the recording medium.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2003-193445 filed on Jul. 8, 2003, and Japanese Patent Application No. 2003-193446 filed on Jul. 8, 2003. The disclosure of the above Japanese Patent Applications are incorporated herein by reference in its entirety.

1. An e-mail management server that comprises:
e-mail receiving means for receiving an e-mail sent to a terminal via a network;
attachment file separating means for separating the e-mail that the e-mail receiving means receives, to a text and an attachment file;
attachment file storing means for storing the attachment file separated by said attachment file separating means, to a predetermined storage region;
e-mail sending means for sending an e-mail that has added to the text, an address of the storage region where the attachment file is stored, via the network;
address receiving means for receiving said address included in said e-mail sent by said e-mail sending means, and
attachment file output controlling means for controlling a predetermined output device to output the attachment file, by reading the attachment file from the storage region, which the address that the address receiving means receives indicates, and sending the attachment file to the output device via the network.

2. An attachment file output system comprising a terminal, an output device, and an e-mail management server connected to the terminal and the output device via a network,
wherein said e-mail management server comprises:
first e-mail receiving means for receiving an e-mail sent to said terminal via the network;
attachment file separating means for separating the e-mail that the first e-mail receiving means receives, to a text and an attachment file;
attachment file storing means for storing the attachment file separated by said attachment file separating means, to a predetermined storage region;
e-mail sending means for sending an e-mail that has added to the text, an address of the storage region where the attachment file is stored, via the network;
address receiving means for receiving said address included in said e-mail sent by said e-mail sending means, and
attachment file output controlling means for controlling a predetermined output device to output the attachment file, by reading the attachment file from the storage region, which the address that the address receiving means receives indicates, and sending the attachment file to the output device via the network.

3. The attachment file output system according to claim 2, wherein said terminal comprises:
second e-mail receiving means for receiving the e-mail sent by said e-mail sending means, and
attachment file output instructing means for instructing output of the attachment file to the e-mail management server, by sending the address included in the e-mail that the second e-mail receiving means receives, to said e-mail management server via the network, in accordance with the user inputting instructions for the attachment file to be output.

4. The attachment file output system according to claim 3, wherein:
said output device is a printing device which prints files sent from the e-mail management server, via the network;
said attachment file output instructing means includes attachment file printing instructing means for instructing printing of the attachment file to the e-mail management server, by sending said address to said e-mail management server via the network, in accordance with the user inputting instructions for the attachment file to be printed, and
said attachment file output controlling means includes attachment file printing controlling means for controlling the first printing apparatus to print the attachment file, by reading the attachment file from the storage region, which the address that the address receiving means receives indicates, and sending the attachment file to said output device via the network.

5. The attachment file output system according to claim 3, wherein:
said output device is a facsimile server that transmits the file sent from the e-mail management server via the network, to a facsimile device designated by said user;
said attachment file output instructing means includes attachment file facsimile transmitting controlling means for controlling a facsimile server to transmit the attachment file to a facsimile device indicating the facsimile number, by reading the attachment file from the storage region, which the address that the address receiving means receives indicates, and sending the attachment file together with the facsimile number, to the facsimile server, via the network, and
said attachment file output controlling means includes attachment file transmitting means for controlling the facsimile server to transmit the attachment file to the facsimile device that the facsimile number indicates, by reading the attachment file from the storage region, which the address that the address receiving means receives indicates, and sending the read attachment file together with the facsimile number to said facsimile server via the network.

6. The attachment file output system according to claim 3, wherein:
said attachment file output instructing means includes user identification information sending means for sending user identification information that can specify a user, together with said address, to the e-mail management server via the network, in response to the user inputting instructions to output the attachment file;
said e-mail management server further comprises user authentication means for carrying out authentication of the user, based on user identification information sent by said user identification information sending means, and
said attachment file output controlling means includes attachment file sending stopping means for stopping sending of said attachment file to said output device, in a case where authentication of the user by said user authentication means is a failure.

7. The attachment file output system according to claim 2, wherein:
said output device is a printing device that prints a file sent from said e-mail management server via the network;
said terminal includes address writing means for writing said address included in the e-mail sent by said e-mail sending means, to a predetermined recording medium, and
said printing device comprises
attachment file sending requesting means for requesting sending of an attachment file to the e-mail management server, by reading said address from the recording medium, and sending the read address to the e-mail management server via the network,
attachment file receiving means for receiving the attachment file sent from the e-mail management server via the network, in accordance with a request by the attachment file sending requesting means, and
attachment file printing means for printing the attachment file received by the attachment file receiving means.

8. The attachment file output system according to claim 7, wherein:
said attachment file sending requesting means includes user identification information sending means for sending user identification information that can specify the user, together with said address, to the e-mail management server, via the network;
said e-mail management server further comprises user authentication means for authenticating the user, based on user identification information sent by the user identification information sending means, and
said attachment file output controlling means includes attachment file sending stopping means for stopping sending of said attachment file to said output device, in a case where authentication of the user by said user authentication means is a failure.

9. The attachment file output system according to claim 2, wherein:
said output device is structured so that it can be connected to said terminal, and is a printing device that prints a file sent from the e-mail management server via the network and the terminal;
said terminal includes address storing means for storing said address included in the e-mail sent by said e-mail sending means, to a predetermined recording medium, and
said printing device comprises
attachment file sending requesting means for requesting sending of an attachment file to the e-mail management server, by reading said address from the recording medium, and sending the read address to the e-mail management server via the terminal and the network,
attachment file receiving means for receiving the attachment file sent from the e-mail management server via the network and the terminal, in accordance with a request by the attachment file sending requesting means, and
attachment file printing means for printing the attachment file received by the attachment file receiving means.

10. The attachment file output system according to claim 9, wherein:
said attachment file sending requesting means includes user identification information sending means for sending user identification information that can specify a user, together with said address, to the e-mail management server via the terminal and the network;
said e-mail management server further comprises user authentication means for carrying out authentication of the user, based on user identification information sent by said user identification information sending means, and
said attachment file output controlling means includes attachment file sending stopping means for stopping sending of said attachment file to said output device, in a case where authentication of the user by said user authentication means is a failure.

11. An attachment file output method comprising:
an e-mail receiving step of receiving an e-mail sent to a terminal via a network;
an attachment file separating step of separating the e-mail that the e-mail receiving step receives, to a text and an attachment file;
an attachment file storing step of storing the attachment file separated by said attachment file separating step, to a predetermined storage region;
an e-mail sending step for sending an e-mail that has added to the text, an address of the storage region where the attachment file is stored, via the network;
an address receiving step of receiving said address included in said e-mail sent by said e-mail sending step, and
an attachment file output controlling step for controlling a predetermined output device to output the attachment file, by reading the attachment file from the storage region, which the address that the address receiving step receives indicates, and sending the attachment file to the output device via the network.

12. A computer readable recording medium which stores a program for controlling a computer to execute:
an e-mail receiving procedure for receiving an e-mail sent to said terminal via the network;
an attachment file separating procedure for separating the e-mail that the first e-mail receiving procedure receives, to a text and an attachment file;
an attachment file storing procedure for storing the attachment file separated by said attachment file separating procedure, to a predetermined storage region;
an e-mail sending procedure for sending an e-mail that has added to the text, an address of the storage region where the attachment file is stored, via the network;
an address receiving procedure of receiving said address included in said e-mail sent by said e-mail sending procedure, and
an attachment file output controlling procedure for controlling a predetermined output device to output the attachment file, by reading the attachment file from the storage region, which the address that the address receiving procedure receives indicates, and sending the attachment file to the output device via the network.

13. A program data signal that is embedded in a carrier wave, and is sent via a communication path, for controlling a computer to execute:
an e-mail receiving procedure for receiving an e-mail sent to said terminal via the network;
an attachment file separating procedure for separating the e-mail that the first e-mail receiving procedure receives, to a text and an attachment file;
an attachment file storing procedure for storing the attachment file separated by said attachment file separating procedure, to a predetermined storage region;
an e-mail sending procedure for sending an e-mail that has added to the text, an address of the storage region where the attachment file is stored, via the network;
an address receiving procedure of receiving said address included in said e-mail sent by said e-mail sending procedure, and
an attachment file output controlling procedure for controlling a predetermined output device to output the attachment file, by reading the attachment file from the storage region, which the address that the address receiving procedure receives indicates, and sending the attachment file to the output device via the network.
